(19) United States
(12) Patent Application Publication
(10) Pub. No.: US 2022/0250690 A1
(43) Pub. Date: Aug. 11, 2022

(54) APPARATUS AND METHOD FOR MANUFACTURING PIPE FOR COWL CROSSBAR

(71) Applicant: HYUNDAI MOBIS Co., Ltd., Seoul (KR)

(72) Inventor: Ik Keun CHOI, Yongin-si (KR)

(73) Assignee: HYUNDAI MOBIS Co., Ltd., Seoul (KR)

(21) Appl. No.: 17/667,328

(22) Filed: Feb. 8, 2022

(30) Foreign Application Priority Data
Feb. 9, 2021 (KR) 10-2021-0018687

(51) Int. Cl. B62D 25/14; B29C 45/00; B29C 70/06; B29C 70/30; B62D 25/08; B62D 29/04

(52) U.S. Cl. CPC B62D 25/145; B29C 45/0005; B29C 70/06; B29K 2105/0872; B62D 25/081; B62D 29/04; B29C 70/30

(57) ABSTRACT

An apparatus for manufacturing a pipe for a cowl crossbar disposed inside a vehicle body in a lateral direction, includes an extruder configured to receive a pipe material and extrude the pipe material; and a compression molding machine, configured to compress the pipe material extruded and form the pipe, comprising a hydraulic cylinder configured to form a hollow part at a center of the pipe material in a longitudinal direction.

### CROSS-REFERENCE TO RELATED APPLICATION

This application claims the benefit under 35 USC 119(a) of Korean Patent Application No. 10-2021-0018687, filed on Feb. 9, 2021, the entire disclosure of which is incorporated herein by reference for all purposes.

### BACKGROUND

### 1. Field

The present disclosure relates to a pipe for a cowl crossbar, and more particularly, to an apparatus and method for manufacturing a pipe for a cowl crossbar of which rigidity is increased while a weight of the pipe is reduced.

### 2. Discussion of Related Art

A cowl crossbar is one part of a cockpit module of a vehicle and serves to guide and support cockpit electronic parts such as a steering shaft, an instrument panel, an air conditioning system, an airbag, a car audio system, and the like.

Further, the cowl crossbar is a framework for preventing bending or warping in a lateral direction of the vehicle and increasing the durability of a vehicle body, and the cowl crossbar protects passengers safely when a vehicle collision accident occurs.

The cowl crossbar includes a pipe, pipe caps coupled to both ends of the pipe, side brackets that are coupled to a corresponding one of the pipe caps to connect the pipe to both ends of the vehicle body, a pin member that passes through the side brackets in a direction of the vehicle body to guide a coupling direction of the vehicle body, a dash mounting member that is formed in a section between both ends of the pipe and fastened to a dash panel, and a central support that is formed in the section between both ends of the pipe and coupled to a lower portion of the vehicle body, and the cowl crossbar occupies about 35% of the weight of the cockpit module and is manufactured by injection-molding a metal material such as steel or the like or a composite material of aluminum, magnesium, plastic, or the like.

Meanwhile, among the entire section of the pipe, a section of the pipe in a direction in which a driver and a center fascia are placed may be formed to have a large diameter such that an amount of deformation of the pipe is minimized when a vehicle collision accident occurs, and the remaining section of the pipe may be formed to have a small diameter such that the weight of the pipe is reduced.

That is, a pipe having a large diameter and a pipe having a small diameter are provided separately and the pipes are bonded through a bracket to manufacture a single pipe.

Therefore, there is a problem in that a manufacturing cost for manufacturing the pipe and the number of manufacturing processes are increased.

Further, among the entire section of the pipe, the rigidity of the section in the direction in which the driver and the center fascia are placed and the rigidity of the remaining section may be formed differently by adjusting a winding ratio of reinforcing materials.

In the method of varying the rigidity of the pipe through the winding of the reinforcing material, it is not possible to bend the pipe so as to be advantageous for the design layout of an interior of the vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an apparatus for manufacturing a pipe for a cowl crossbar disposed inside a vehicle body in a lateral direction, includes an extruder configured to receive a pipe material and extrude the pipe material; and a compression molding machine, configured to compress the pipe material extruded and form the pipe, including a hydraulic cylinder configured to form a hollow part at a center of the pipe material in a longitudinal direction.

The compression molding machine may further include an upper mold configured to press an upper portion of the pipe material extruded, and a lower mold configured to press a lower portion of the pipe material extruded.

The upper mold may include an upper body part, an upper large-diameter forming part formed on a lower surface of the upper body part to form a large-diameter part of the pipe, and an upper small-diameter forming part formed in a region of the lower surface of the upper body part, adjacent to the upper large-diameter forming part, to form a small-diameter part of the pipe. The lower mold may include a lower body part, a lower large-diameter forming part formed on an upper surface of the lower body part to form the large-diameter part of the pipe, and a lower small-diameter forming part formed in a region of the upper surface of the lower body part, adjacent to the lower large-diameter forming part, to form the small-diameter part of the pipe.

A height of the upper large-diameter forming part and a height of the upper small-diameter forming part may be different from each other. A height of the lower large-diameter forming part and a height of the lower small-diameter forming part may be different from each other.

The extruder may include a first extruder configured to receive a polypropylene (PP) pipe material, and a second extruder configured to receive a long glass fiber (LGF) pipe material.

In another general aspect, a method of manufacturing a pipe for a cowl crossbar disposed inside a vehicle body in a lateral direction, includes arranging a hydraulic cylinder in an upper mold and a lower mold; placing a pipe material between the upper mold and the hydraulic cylinder, and between the lower mold and the hydraulic cylinder; sliding the upper mold and the lower mold toward the hydraulic cylinder, pressing the pipe material against an outer circumferential surface of the hydraulic cylinder, and forming the pipe; separating the hydraulic cylinder from the pipe; and sliding the upper mold and the lower mold in a direction away from the hydraulic cylinder and performing form removal on the pipe from the upper mold and the lower mold.

The pipe material may be a combination of polypropylene (PP) and long glass fiber (LGF).

The pipe material may include 50% PP and 50% LGF.

The pipe material may include 40% PP and 60% LGF.

The pipe may include a large-diameter part and a small-diameter part. A section of the large-diameter part may be more rigid that a section of the small-diameter part, and a weight of the section of the small-diameter part may be less than a weight of the section of the large-diameter part. The hydraulic cylinder may include a first hydraulic cylinder configured to receive the large-diameter part, and a second hydraulic cylinder configured to receive the small-diameter part.

An outer diameter of the large-diameter part may be greater than an outer diameter of the small-diameter part. An outer diameter of the first hydraulic cylinder may be identical to an inner diameter of the large-diameter part. An outer diameter of the second hydraulic cylinder may be identical to an inner diameter of the small-diameter part.

In another general aspect, an apparatus for manufacturing a pipe for a cowl crossbar disposed inside a vehicle body in a lateral direction, includes an extruder configured to receive a pipe material and extrude the pipe material; a compression molding machine configured to compress the pipe material extruded and form a pipe; and an insert bracket, disposed inside the compression molding machine to bend the pipe, including a first bracket coupled to an inner circumferential surface of a large-diameter part of the pipe, a second bracket spaced apart from the first bracket and in contact with an inner circumferential surface of a small-diameter part of the pipe, and a connection part configured to connect the first bracket to the second bracket.

The insert bracket may be made of aluminum (Al).

In another general aspect, a method of manufacturing a pipe for a cowl crossbar disposed inside a vehicle body in a lateral direction and to which an insert bracket is coupled, includes arranging an insert bracket between a pair of hydraulic cylinders; arranging the pair of hydraulic cylinders and the insert bracket in an upper mold and a lower mold; placing a pipe material between the upper mold and the hydraulic cylinder and between the lower mold and the hydraulic cylinder; sliding the upper mold and the lower mold toward the hydraulic cylinders, pressing the pipe material against outer circumferential surfaces of the hydraulic cylinders, and forming the pipe; separating the hydraulic cylinders from the pipe; and sliding the upper mold and the lower mold in a direction away from the hydraulic cylinders and performing form removal on the pipe from the upper mold and the lower mold.

A center of a cross section of the first bracket and a center of a cross section of the second bracket may be different from each other.

Other features and aspects will be apparent from the following detailed description, the drawings, and the claims.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic view illustrating a pipe manufacturing process using an apparatus for manufacturing a pipe for a long fiber-reinforced thermoplastics by direct compounding (LFT-D) press method according to a method of manufacturing a pipe for a cowl crossbar of the present disclosure;

FIG. 2 is a cross-sectional view in one direction illustrating a compression molding machine of the apparatus for manufacturing the pipe for a cowl crossbar of the present disclosure;

FIG. 3 is a cross-sectional view in another direction illustrating the compression molding machine of the apparatus for manufacturing the pipe for a cowl crossbar of the present disclosure;

FIGS. 4A to 4E are process diagrams illustrating a method of manufacturing a pipe for a cowl crossbar according to an embodiment of the present disclosure;

FIG. 5 is a flowchart illustrating the method of manufacturing the pipe for a cowl crossbar according to the embodiment of the present disclosure;

FIGS. 6A and 6B are a perspective view and a cross-sectional view illustrating the pipe for a cowl crossbar according to the embodiment of the present disclosure;

FIG. 7 is a cross-sectional view in one direction illustrating a compression molding machine of an apparatus for manufacturing a pipe for a cowl crossbar of the present disclosure;

FIGS. 8A to 8F are process diagrams illustrating a method of manufacturing a pipe for a cowl crossbar according to another embodiment of the present disclosure;

FIG. 9 is a flowchart illustrating the method of manufacturing the pipe for a cowl crossbar according to another embodiment of the present disclosure; and

FIGS. 10A and 10B are a perspective view and a cross-sectional view illustrating the pipe for a cowl crossbar according to another embodiment of the present disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

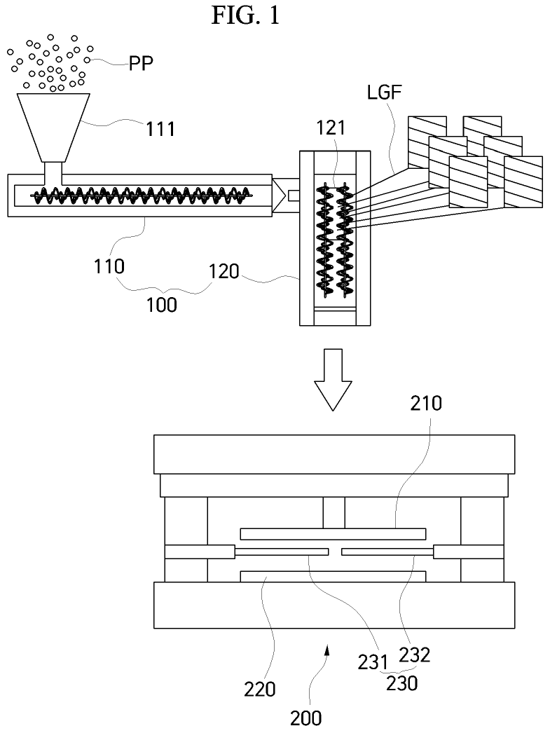

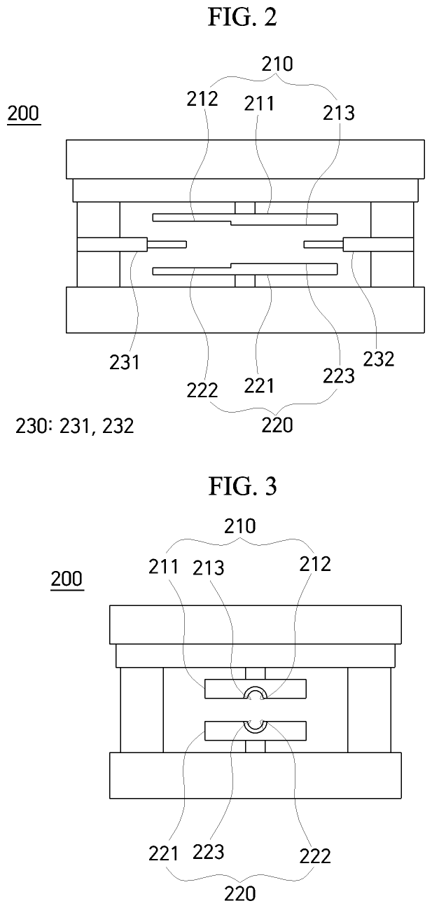

FIG. 1 is a schematic view illustrating a pipe manufacturing process using an apparatus for manufacturing a pipe for a long fiber-reinforced thermoplastics by direct compounding (LFT-D) press method according to a method of manufacturing a pipe for a cowl crossbar of the present disclosure, FIG. 2 is a cross-sectional view in one direction illustrating a compression molding machine of the apparatus for manufacturing the pipe for a cowl crossbar of the present disclosure, and FIG. 3 is a cross-sectional view in another direction illustrating the compression molding machine of the apparatus for manufacturing the pipe for a cowl crossbar of the present disclosure.

Referring to FIGS. 1 to 3, a pipe 300 for a cowl crossbar disposed in an inside of a vehicle body in a lateral direction is manufactured using an LFT-D press method.

In the LFT-D press method, various types of equipment are used for a process from raw materials to finished products due to the characteristic of the process, and the LFT-D press method is a method of making a product by mixing raw materials, extruding the mixed raw materials, and then performing press-molding using a compression molding machine 200.

The LFT-D press method enables serial processing from raw material mixing and extrusion to press-molding, and has higher productivity than injection-molding.

An apparatus for manufacturing the pipe 300 for a cowl crossbar for the LFT-D press method includes an extruder 100 and a compression molding machine 200 as illustrated in FIG. 1.

A pipe material 301 is put into the extruder 100 and the extruder 100 extrudes the put pipe material 301.

The extruder 100 includes a first extruder 110 and a second extruder 120.

The first extruder 110 has a first inlet 111 formed therein and a pipe material 301 made of polypropylene (PP) is put into the first extruder 110 through the first inlet 111.

Further, the PP is melted by the first extruder 110 and extruded by the second extruder 120.

The second extruder 120 has a second inlet 121 formed therein and a pipe material 301 made of long glass fiber (LGF) is put into the second extruder 120 through the second inlet 121.

That is, in the present disclosure, the pipe material 301 for manufacturing the pipe 300 for a cowl crossbar is made of a combination of the PP and the LGF.

Further, by putting the LGF separately from the PP through the second inlet 121, excessive cutting of the fiber may be prevented.

The compression molding machine 200 compresses the pipe material 301 made of the PP and the LGF, which is extruded from the extruder 100, specifically, the second extruder 120, to form the pipe 300.

Referring to FIGS. 2 and 3, the compression molding machine 200 includes an upper mold 210 and a lower mold 220.

The upper mold 210 presses an upper portion of the pipe material 301 extruded from the second extruder 120.

The upper mold 210 includes an upper body part 211, an upper large-diameter forming part 212, and an upper small-diameter forming part 213.

The upper body part 211 of the upper mold 210 forms a body of the upper mold 210.

Further, the upper large-diameter forming part 212 is formed on a lower surface of the upper body part 211 which is brought into contact with the pipe material 301.

The upper large-diameter forming part 212 presses the pipe material 301 to form a large-diameter part 310 of the pipe 300 at an upper side of the pipe 300.

In addition, the upper small-diameter forming part 213 is formed in a region of the lower surface of the upper body part 211 which is adjacent to the upper large-diameter forming part 212.

The upper small-diameter forming part 213 presses the pipe material 301 to form a small-diameter part 320 of the pipe 300 at the upper side of the pipe 300.

A height of the upper large-diameter forming part 212 and a height of the upper small-diameter forming part 213 are different from each other.

Specifically, in the upper mold 210, the upper large-diameter forming part 212 that forms the large-diameter part 310 of the pipe 300 is formed at a higher position than the upper small-diameter forming part 213 that forms the small-diameter part 320 of the pipe 300.

Therefore, in the pipe 300 of the present disclosure, when the upper mold 210 presses the pipe material 301, the upper large-diameter forming part 212 is brought into contact with the pipe material 301 later than the upper small-diameter forming part 213.

Accordingly, the upper mold 210 may form the large-diameter part 310 and the small-diameter part 320 of the pipe 300 so that the large-diameter part 310 and the small-diameter part 320 of the pipe 300 have different thicknesses according to shapes of the upper large-diameter forming part 212 and the upper small-diameter forming part 213.

A lower body part 221 of the lower mold 220 forms a body of the lower mold 220.

Further, a lower large-diameter forming part 222 is formed on an upper surface of the lower body part 221 which is brought into contact with the pipe material 301.

The lower large-diameter forming part 222 presses the pipe material 301 to form the large-diameter part 310 of the pipe 300 at a lower side of the pipe 300.

In addition, a lower small-diameter forming part 223 is formed in a region of the upper surface of the lower body part 221 which is adjacent to the lower large-diameter forming part 222.

The lower small-diameter forming part 223 presses the pipe material 301 to form the small-diameter part 320 of the pipe 300 at the lower side of the pipe 300.

A height of the lower large-diameter forming part 222 and a height of the lower small-diameter forming part 223 are different from each other.

Specifically, in the lower mold 220, the lower large-diameter forming part 222 that forms the large-diameter part 310 of the pipe 300 is formed at a lower position than the lower small-diameter forming part 223 that forms the small-diameter part 320 of the pipe 300.

Therefore, in the pipe 300 of the present disclosure, when the lower mold 220 presses the pipe material 301, the lower large-diameter forming part 222 is brought into contact with the pipe material 301 later than the lower small-diameter forming part 223.

That is, the lower mold 220 may form the large-diameter part 310 and the small-diameter part 320 of the pipe 300 so that the large-diameter part 310 and the small-diameter part 320 of the pipe 300 have different thicknesses according to shapes of the lower large-diameter forming part 222 and the lower small-diameter forming part 223.

Accordingly, the pipe 300 manufactured by the apparatus for manufacturing the pipe 300 of the present disclosure may be manufactured so as to be clearly and easily divided into a section requiring rigidity and a section capable of reducing a weight rather than the rigidity, and in particular, a degree of freedom for manufacturing different thicknesses and shapes of the pipe 300 may be increased.

A hydraulic cylinder 230 may easily form a hollow part 330 of the pipe 300.

Further, the hydraulic cylinder 230 is disposed parallel to the upper mold 210 and the lower mold 220.

Accordingly, the hydraulic cylinder may form the pipe 300 in the form of a straight line.

The hydraulic cylinder 230 includes a first hydraulic cylinder 231 and a second hydraulic cylinder 232.

The large-diameter part 310 is disposed in the first hydraulic cylinder 231 and the small-diameter part 320 is disposed in the second hydraulic cylinder 232.

Further, an outer diameter of the first hydraulic cylinder 231 is identical to an inner diameter of the large-diameter part 310, and an outer diameter of the second hydraulic cylinder 232 is identical to an inner diameter of the small-diameter part 320.

Therefore, the first hydraulic cylinder 231 and the second hydraulic cylinder 232 may easily form an inner circumferential surface of the pipe 300 by using the LFT-D press method.

Hereinafter, a method of manufacturing a pipe for a cowl crossbar using the apparatus for manufacturing the pipe for a cowl crossbar will be described with reference to the accompanying drawings.

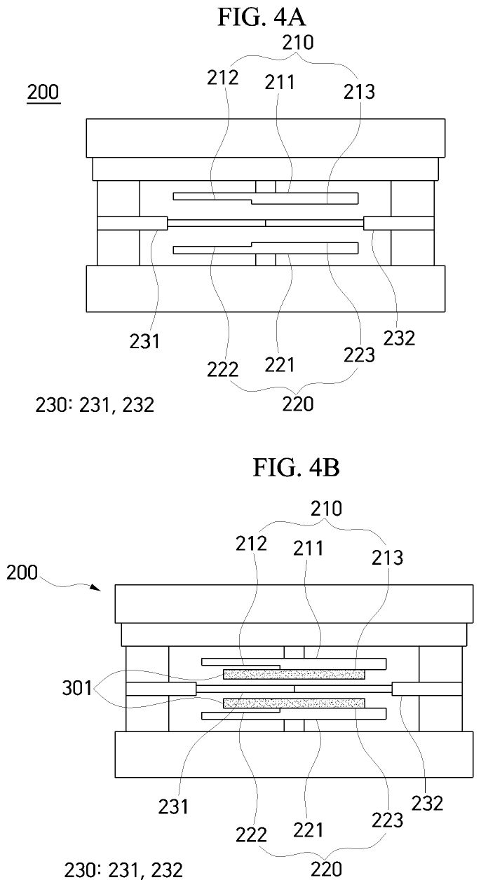

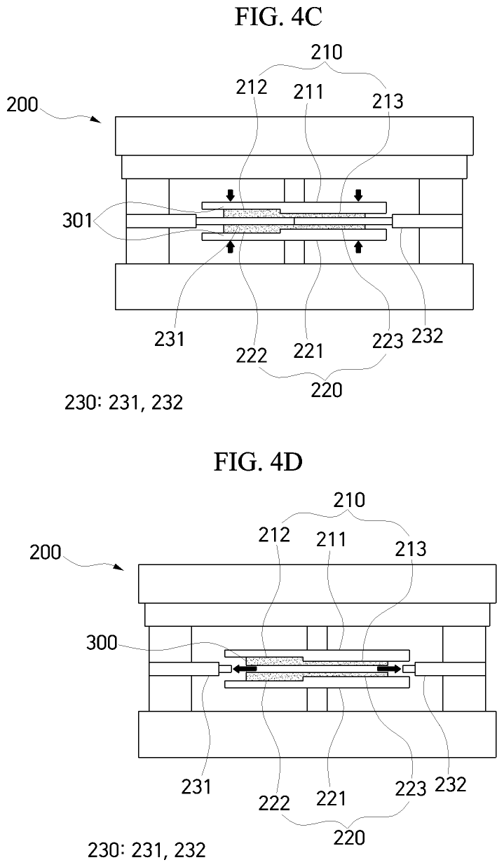

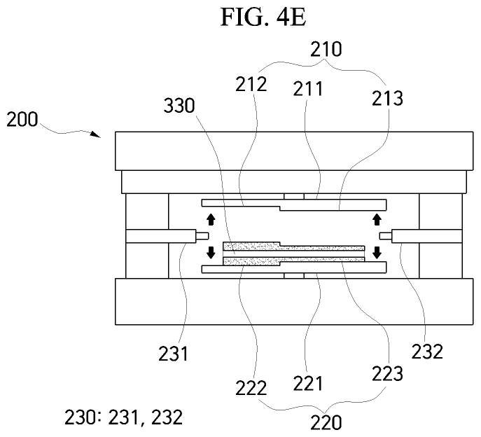

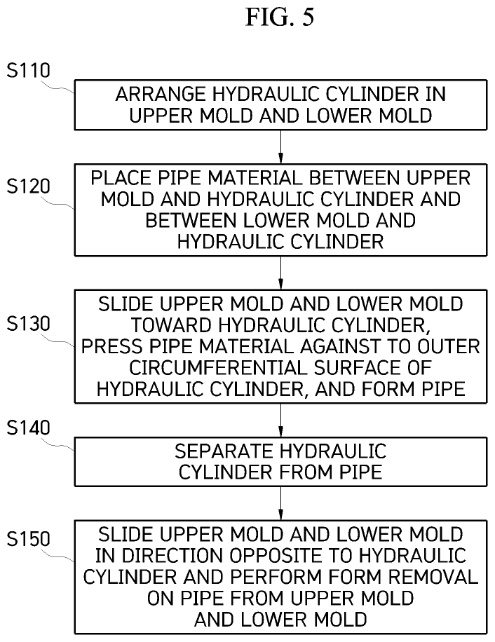

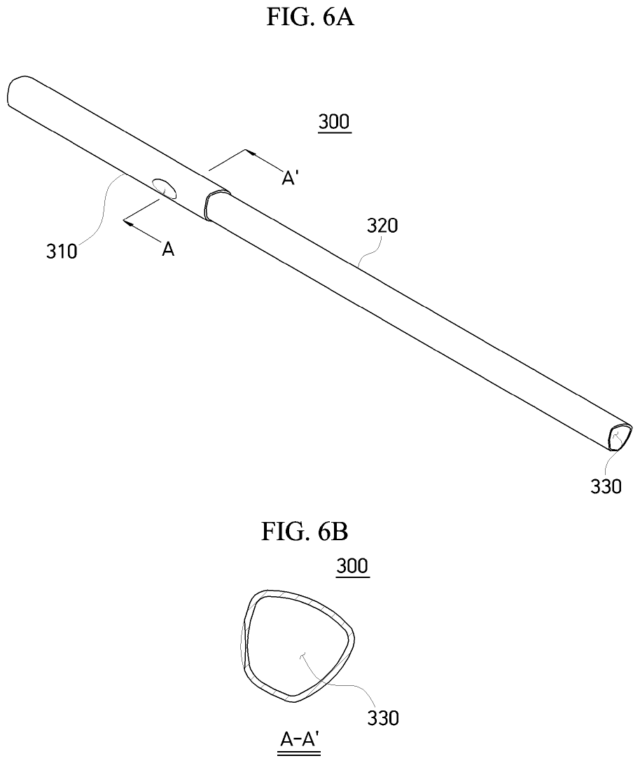

FIGS. 4A to 4E are process diagrams illustrating a method of manufacturing a pipe for a cowl crossbar according to an embodiment of the present disclosure, FIG. 5 is a flowchart illustrating the method of manufacturing the pipe for a cowl crossbar according to the embodiment of the present disclosure, and FIGS. 6A and 6B are a perspective view and a cross-sectional view illustrating the pipe for a cowl crossbar according the embodiment of the present disclosure.

First, as illustrated in FIG. 1, PP is put into the first extruder 110 through the first inlet 111, and LGF is put into the second extruder 120 through the second inlet 121.

That is, in the present disclosure, the pipe material 301 for manufacturing the pipe 300 for a cowl crossbar is made of a combination of the PP and the LGF.

Here, a content of the PP may be 50%, and a content of the LGF may be 50%.

Further, a content of the PP may be 40%, and a content of the LGF may be 60%.

When the content of the PP is less than 40%, there may be a problem in that the weight of the pipe material 301 is increased due to a relatively high content of the LGF, and when the content of the PP exceeds 50%, there may be a problem in that mechanical characteristics of the pipe material 301 are degraded.

Further, the LGF is used to improve the mechanical characteristics of the pipe 300 and the content of the LGF may range from about 50 to 60%, as described above.

When the content of the LGF is too small, there may be a problem in that the weight of the pipe material 301 is lowered but the mechanical characteristics such as strength, durability, and the like are degraded, and when the content of the LGF exceeds 60%, there may be a problem in that the weight of the pipe material 301 is increased.

Since the pipe 300 using the PP and LGF materials has a very superior vibration absorption property due to the material characteristics as compared to steel, the vibration of the steering wheel, which is caused by idling when the vehicle is stopped or driving, may be suppressed, and thus noise, vibration, and harshness (NVH) performance may be improved.

Next, the PP is melted by the first extruder 110 and extruded by the second extruder 120.

Further, the second extruder 120 melts and mixes the PP and the LGF which are extruded from the first extruder 110.

Here, the extrusion refers to a process of compounding by melting and mixing raw materials.

Next, the pipe 300 is manufactured by compressing the pipe material 301 made of the PP and the LGF using the compression molding machine 200.

Specifically, as illustrated in FIG. 4A, the hydraulic cylinder 230 is disposed in the upper mold 210 and the lower mold 220 (S110).

In this case, the hydraulic cylinder 230 is disposed parallel to the upper mold 210 and the lower mold 220.

Further, as illustrated in FIG. 4B, the pipe material 301 made of the PP and the LGF is placed between the upper mold 210 and the hydraulic cylinder 230 and between the lower mold 220 and the hydraulic cylinder 230 (S120).

Next, as illustrated in FIG. 4C, the upper mold 210 and the lower mold 220 are slid toward the hydraulic cylinder 230 (S130).

That is, the pipe material 301 made of the PP and the LGF is pressed against an outer circumferential surface of the hydraulic cylinder 230 to form the pipe 300.

Meanwhile, the pipe 300 fixed to left and right sides of a vehicle body includes the large-diameter part 310 and the small-diameter part 320.

The large-diameter part 310 should have rigidity so as to minimize an amount of deformation, and the small-diameter part 320 should be able to reduce a total weight of the pipe 300.

Therefore, the rigidity of the large-diameter part 310 and the rigidity of the small-diameter part 320 should be different according to the section.

That is, the large-diameter part 310 is a section that should have rigidity so that the amount of deformation is minimized, and is formed to have a relatively large thickness, and the small-diameter part 320 is a section, in which the total weight of the pipe 300 may be reduced, and is formed to have a relatively small thickness.

In other words, an outer diameter of the large-diameter part 310 is greater than an outer diameter of the small-diameter part 320.

Next, as illustrated in FIG. 4D, the hydraulic cylinder 230, that is, the first hydraulic cylinder 231 and the second hydraulic cylinder 232, are separated from the pipe 300, that is, the large-diameter part 310 and the small-diameter part 320, respectively (S140).

Further, the upper mold 210 and the lower mold 220 are slid in a direction opposite to a direction in which the hydraulic cylinder 230 is disposed.

Next, as illustrated in FIG. 4E, when the upper mold 210 and the lower mold 220 are separated from the pipe 300, form removal is performed on the pipe 300 from the upper mold 210 and the lower mold 220 (S150).

The pipe 300 according to the embodiment of the present disclosure manufactured as described above may be manufactured in an integrated structure and, at the same time, may be manufactured so as to be clearly and easily divided into the large-diameter part 310, which is a section requiring rigidity, and the small-diameter part 320, which is a section that can reduce the weight rather than the rigidity, according to the shapes of the upper mold 210 and the lower mold 220, as illustrated in FIG. 6B.

That is, a degree of freedom for manufacturing different thicknesses and shapes of the pipe 300 may be increased.

Further, an outer diameter of the first hydraulic cylinder 231 is identical to an inner diameter of the large-diameter part 310 and an outer diameter of the second hydraulic cylinder 232 is identical to an inner diameter of the small-diameter part 320, and thus the first hydraulic cylinder 231 and the second hydraulic cylinder 232 may easily form an inner circumferential surface of the pipe 300 by using a LFT-D press method.

In particular, in the present disclosure, as illustrated in FIG. 6A, an outer circumferential surface of the pipe 300 may be three-dimensionally formed without a separate foaming process according to the shapes of the upper mold 210 and the lower mold 220 to give a foaming effect.

Meanwhile, although the pipe according to the embodiment of the present disclosure is described as being formed in the form of a straight line, a pipe according to another embodiment of the present disclosure may be formed to have a bent shape according to a design layout of a mounting space in an interior of a vehicle.

Hereinafter, an apparatus for manufacturing a pipe according to another embodiment of the present disclosure, which is disposed inside a vehicle body in a lateral direction and to which an insert bracket is coupled, will be described.

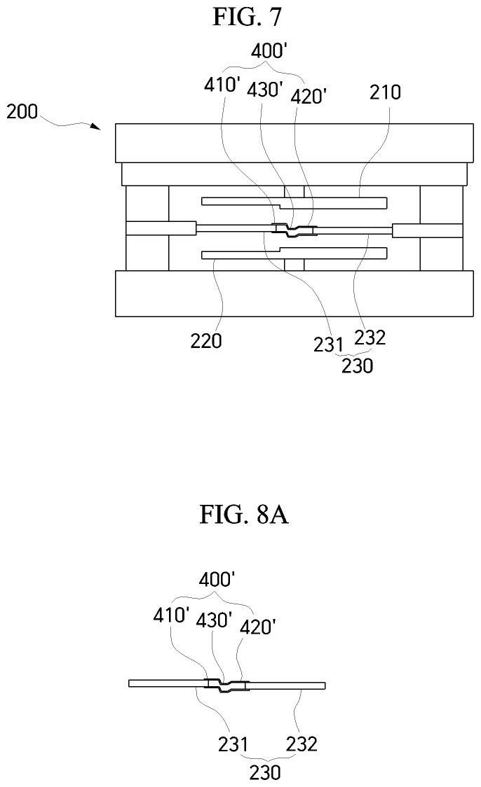

FIG. 7 is a cross-sectional view in one direction illustrating a compression molding machine of an apparatus for manufacturing a pipe for a cowl crossbar of the present disclosure.

The same reference numerals are used for the same components as those described in the above-described embodiment, and detailed descriptions thereof will be omitted.

An apparatus for manufacturing a pipe for a cowl crossbar for a LFT-D press method includes an extruder 100, a compression molding machine 200, and an insert bracket 400′.

A pipe material 301′ is put into the extruder 100 and the extruder 100 extrudes the put pipe material 301′.

The compression molding machine 200 compresses the pipe material 301′ made of PP and LGF′ extruded from the extruder 100, specifically, a second extruder 120, to form a pipe 300′.

The insert bracket 400′ is disposed inside the compression molding machine 200 to bend the pipe 300′ formed by the compression molding machine 200.

Further, the insert bracket 400′ is made of aluminum (Al).

That is, since the insert bracket 400′ is made of Al, a total weight of the pipe 300′ may be reduced due to the characteristics of Al.

The insert bracket 400′ includes a first bracket 410′, a second bracket 420′, and a connection part 430′.

The first bracket 410′ is in contact with an inner circumferential surface of a large-diameter part 310′ requiring rigidity in the pipe 300′, and the second bracket 420′ is spaced apart from the first bracket 410′ that can reduce the weight of the pipe 300′ and is in contact with an inner circumferential surface of a small-diameter part 320′.

Further, the connection part 430′ is disposed between the first bracket 410′ and the second bracket 420′ to connect the first bracket 410′ to the second bracket 420′.

Hereinafter, a method of manufacturing a pipe according to another embodiment of the present disclosure, which is disposed inside a vehicle body in a lateral direction and to which an insert bracket is coupled, will be described.

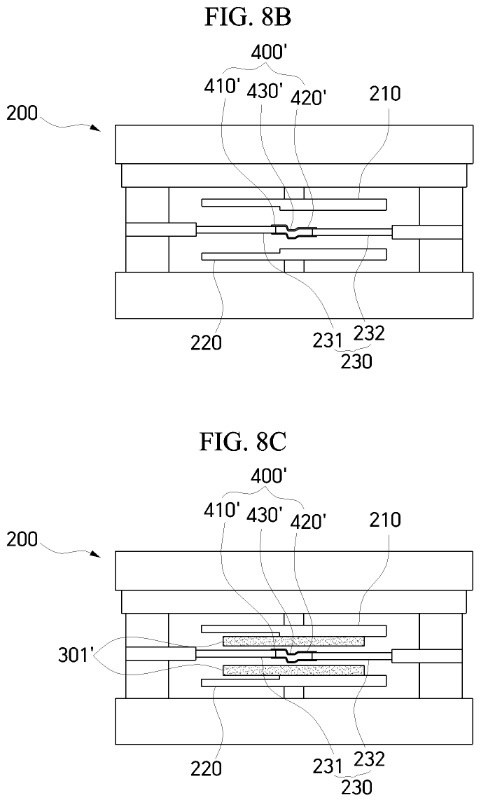

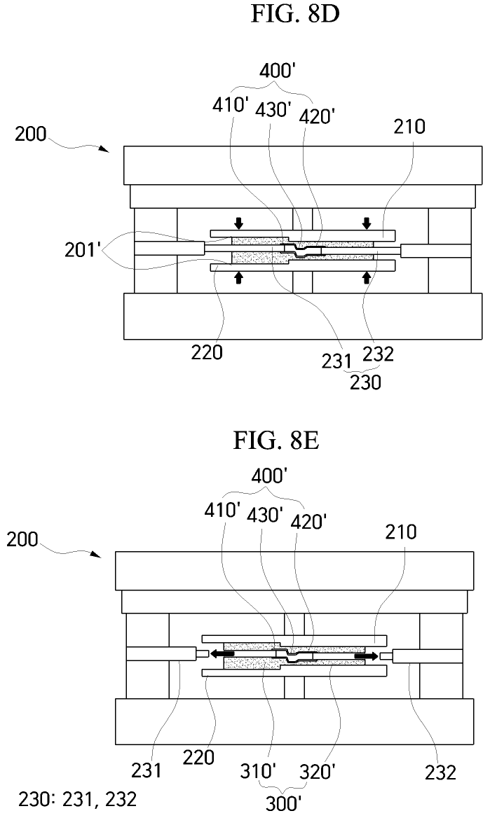

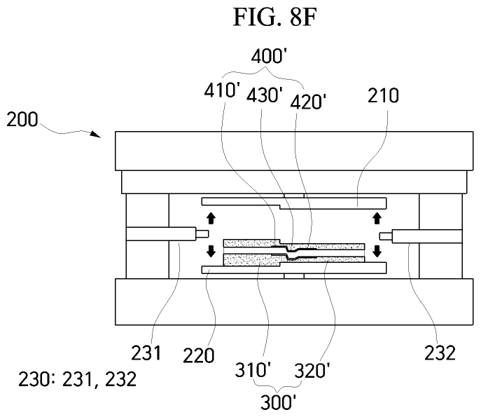

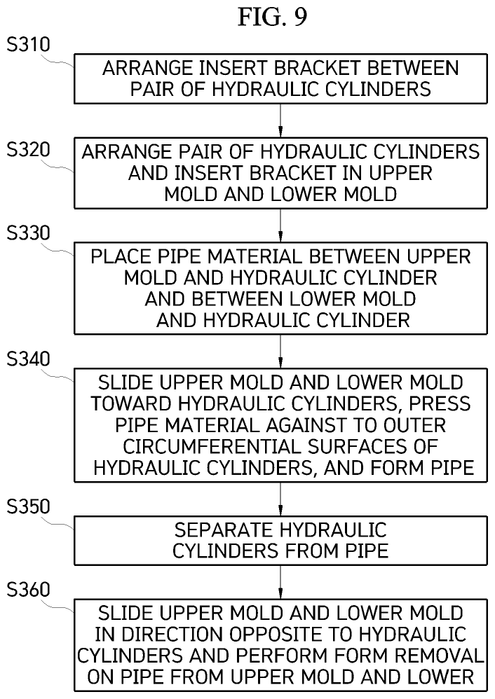

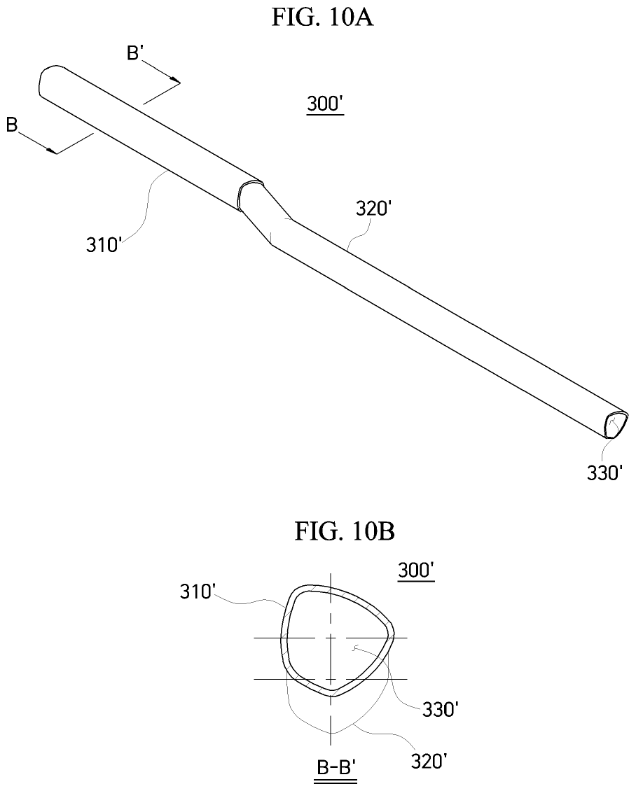

FIGS. 8A to 8F are process diagrams illustrating a method of manufacturing a pipe for a cowl crossbar according to another embodiment of the present disclosure, FIG. 9 is a flowchart illustrating the method of manufacturing the pipe for a cowl crossbar according to another embodiment of the present disclosure, and FIGS. 10A and 10B are a perspective view and a cross-sectional view illustrating the pipe for a cowl crossbar according to another embodiment of the present disclosure.

The same reference numerals are used for the same components as those described in the above-described embodiment, and detailed descriptions thereof will be omitted.

First, as illustrated in FIG. 8A, an insert bracket 400′ is disposed between a first hydraulic cylinder 231 and a second hydraulic cylinder 232 constituting a compression molding machine 200 (S310).

The insert bracket 400′ includes a first bracket 410′, a second bracket 420′, and a connection part 430′, the first bracket 410′ is in contact with an inner circumferential surface of a large-diameter part 310′ of a pipe 300′, and the second bracket 420′ is in contact with an inner circumferential surface of a small-diameter part 320′ of the pipe 300′.

Meanwhile, the connection part 430′ connects the first bracket 410′ to the second bracket 420′ and extends from an end portion of the first bracket 410′ to an end portion of the second bracket 420′ to have an inclined shape.

Accordingly, as illustrated in FIG. 10B, a center of a cross section of the first bracket 410′ and a center of a cross section of the second bracket 420′ are different from each other.

That is, the first bracket 410′ and the second bracket 420′ are formed to have different heights due to the connection part 430′.

Next, as illustrated in FIG. 8B, the large-diameter part 310′ and the small-diameter part 320′, to which the insert bracket 400′ is coupled, are disposed between an upper mold 210 and a lower mold 220 (S320).

Further, as illustrated in FIG. 8C, a pipe material 301′ made of PP and LGF′ is placed between the upper mold 210 and a hydraulic cylinder 230 and between the lower mold 220 and the hydraulic cylinder 230 (S330).

Next, as illustrated in FIG. 8D, the upper mold 210 and the lower mold 220 are slid toward the hydraulic cylinder 230 (S340).

That is, the pipe material 301′ made of the PP and the LGF′ is pressed against an outer circumferential surface of the hydraulic cylinder 230 to form the pipe 300′.

In this case, the pipe 300′ may be formed to have a hollow shape due to the hydraulic cylinder 230.

Further, the first bracket 410′ and the second bracket 420′ are formed to have different heights due to the connection part 430′ of the insert bracket 400′, in which the pipe material 301′ is in contact with an outer circumferential surface of the connection part 430′, and thus the large-diameter part 310′ in contact with the first bracket 410′ and the second bracket 420′ in contact with the second bracket 420′ are formed to have an entirely bent shape.

Meanwhile, the hydraulic cylinder 230 includes a first hydraulic cylinder 231 and a second hydraulic cylinder 232.

The large-diameter part 310′ is disposed in the first hydraulic cylinder 231, and the small-diameter part 320′ is disposed in the second hydraulic cylinder 232.

Further, an outer diameter of the first hydraulic cylinder 231 is identical to an inner diameter of the large-diameter part 310′, and an outer diameter of the second hydraulic cylinder 232 is identical to an inner diameter of the small-diameter part 320.

Therefore, the first hydraulic cylinder 231 and the second hydraulic cylinder 232 may easily form an inner circumferential surface of the pipe 300′ by using the LFT-D press method.

Next, as illustrated in FIG. 8E, the hydraulic cylinder 230, that is, the first hydraulic cylinder 231 and the second hydraulic cylinder 232, are separated from the pipe 300′, that is, the large-diameter part 310′ and the small-diameter part 320′, respectively (S350).

Further, the upper mold 210 and the lower mold 220 are slid in a direction opposite to the hydraulic cylinder 230.

Therefore, as illustrated in FIG. 8F, the pipe 300′ is separated from the upper mold 210 and the lower mold 220 (S360).

The pipe 300′ according to another embodiment of the present disclosure manufactured as described above may be manufactured in an integrated structure and at the same time, may be manufactured so as to be clearly and easily divided into the large-diameter part 310′, which is a section requiring rigidity, and the small-diameter part 320′, which is a section that can reduce the weight rather than the rigidity, according to the shapes of the upper mold 210 and the lower mold 220, as illustrated in FIG. 10A.

In particular, as illustrated in FIG. 10B, in the pipe 300′ according to another embodiment of the present disclosure, the first bracket 410′ and the second bracket 420′ having different centers of cross-sections are coupled between the large-diameter part 310′ and the small-diameter part 320′ to entirely bend the pipe 300′, and thus the pipe 300′ may be manufactured according to parts mounted in an interior of a vehicle or a design layout of the interior of the vehicle.

According to the present disclosure, a pipe can be manufactured in an integrated structure and at the same time, can be manufactured so as to be clearly and easily divided into a section requiring rigidity and a section that can reduce the weight rather than the rigidity according to shapes of an upper mold and a lower mold.

Further, an outer diameter of a first hydraulic cylinder is identical to an inner diameter of a large-diameter part and an outer diameter of a second hydraulic cylinder is identical to an inner diameter of a small-diameter part, and thus the first hydraulic cylinder and the second hydraulic cylinder can easily form an inner circumferential surface of the pipe by using a LFT-D press method.

In addition, an outer circumferential surface of the pipe can be three-dimensionally formed without a separate foaming process according to the shapes of the upper mold and the lower mold to give a foaming effect.

Further, a first bracket and a second bracket having different centers of cross-sections can be coupled between a large-diameter part and a small-diameter part to entirely bend the pipe, and thus the pipe can be manufactured according to parts mounted in an interior of a vehicle or a design layout of the interior of the vehicle.

The present disclosure is directed to solving the above-described problems and providing an apparatus and method for manufacturing a pipe for a cowl crossbar of which rigidity is increased while a weight of the pipe is reduced, and the pipe is bent according to a design layout of a vehicle.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus for manufacturing a pipe for a cowl crossbar disposed inside a vehicle body in a lateral direction, the apparatus comprising:
an extruder configured to receive a pipe material and extrude the pipe material; and
a compression molding machine, configured to compress the pipe material extruded and form the pipe, comprising a hydraulic cylinder configured to form a hollow part at a center of the pipe material in a longitudinal direction.

2. The apparatus of claim 1, wherein the compression molding machine further comprises:
an upper mold configured to press an upper portion of the pipe material extruded; and
a lower mold configured to press a lower portion of the pipe material extruded.

3. The apparatus of claim 2, wherein:
the upper mold comprises an upper body part,
an upper large-diameter forming part formed on a lower surface of the upper body part to form a large-diameter part of the pipe, and
an upper small-diameter forming part formed in a region of the lower surface of the upper body part, adjacent to the upper large-diameter forming part, to form a small-diameter part of the pipe; and
the lower mold comprises a lower body part,
a lower large-diameter forming part formed on an upper surface of the lower body part to form the large-diameter part of the pipe, and
a lower small-diameter forming part formed in a region of the upper surface of the lower body part, adjacent to the lower large-diameter forming part, to form the small-diameter part of the pipe.

4. The apparatus of claim 3, wherein:
a height of the upper large-diameter forming part and a height of the upper small-diameter forming part are different from each other; and
a height of the lower large-diameter forming part and a height of the lower small-diameter forming part are different from each other.

5. The apparatus of claim 1, wherein the extruder comprises:
a first extruder configured to receive a polypropylene (PP) pipe material; and
a second extruder configured to receive a long glass fiber (LGF) pipe material.

6. A method of manufacturing a pipe for a cowl crossbar disposed inside a vehicle body in a lateral direction, the method comprising:
arranging a hydraulic cylinder in an upper mold and a lower mold;
placing a pipe material between the upper mold and the hydraulic cylinder, and between the lower mold and the hydraulic cylinder;
sliding the upper mold and the lower mold toward the hydraulic cylinder, pressing the pipe material against an outer circumferential surface of the hydraulic cylinder, and forming the pipe;
separating the hydraulic cylinder from the pipe; and
sliding the upper mold and the lower mold in a direction away from the hydraulic cylinder and performing form removal on the pipe from the upper mold and the lower mold.

7. The method of claim 6, wherein the pipe material is a combination of polypropylene (PP) and long glass fiber (LGF).

8. The method of claim 7, wherein the pipe material comprises 50% PP and 50% LGF.

9. The method of claim 7, wherein the pipe material comprises 40% PP and 60% LGF.

10. The method of claim 6, wherein:
the pipe comprises a large-diameter part and a small-diameter part,
a section of the large-diameter part is more rigid that a section of the small-diameter part, and
a weight of the section of the small-diameter part is less than a weight of the section of the large-diameter part; and
the hydraulic cylinder comprises a first hydraulic cylinder configured to receive the large-diameter part, and
a second hydraulic cylinder configured to receive the small-diameter part.

11. The method of claim 10, wherein:
an outer diameter of the large-diameter part is greater than an outer diameter of the small-diameter part;
an outer diameter of the first hydraulic cylinder is identical to an inner diameter of the large-diameter part; and
an outer diameter of the second hydraulic cylinder is identical to an inner diameter of the small-diameter part.

12. An apparatus for manufacturing a pipe for a cowl crossbar disposed inside a vehicle body in a lateral direction, the apparatus comprising:
an extruder configured to receive a pipe material and extrude the pipe material;
a compression molding machine configured to compress the pipe material extruded and form a pipe; and
an insert bracket, disposed inside the compression molding machine to bend the pipe, comprising a first bracket coupled to an inner circumferential surface of a large-diameter part of the pipe, a second bracket spaced apart from the first bracket and in contact with an inner circumferential surface of a small-diameter part of the pipe, and a connection part configured to connect the first bracket to the second bracket.

13. The apparatus of claim 12, wherein the insert bracket is made of aluminum (Al).

14. A method of manufacturing a pipe for a cowl crossbar disposed inside a vehicle body in a lateral direction and to which an insert bracket is coupled, the method comprising:
arranging an insert bracket between a pair of hydraulic cylinders;
arranging the pair of hydraulic cylinders and the insert bracket in an upper mold and a lower mold;
placing a pipe material between the upper mold and the hydraulic cylinder and between the lower mold and the hydraulic cylinder;
sliding the upper mold and the lower mold toward the hydraulic cylinders, pressing the pipe material against outer circumferential surfaces of the hydraulic cylinders, and forming the pipe;
separating the hydraulic cylinders from the pipe; and
sliding the upper mold and the lower mold in a direction away from the hydraulic cylinders and performing form removal on the pipe from the upper mold and the lower mold.

15. The method of claim 14, wherein a center of a cross section of the first bracket and a center of a cross section of the second bracket are different from each other.
